(19) United States
(12) Patent Application Publication
(10) Pub. No.: US 2011/0076109 A1
(43) Pub. Date: Mar. 31, 2011

(54) Blind Fasteners and Methods of Manufacture

(75) Inventor: Paul A. Keller, La Habra, CA (US)

(73) Assignee: ALLFAST FASTENING SYSTEMS, INC., City of Industry, CA (US)

(21) Appl. No.: 12/890,307

(22) Filed: Sep. 24, 2010

Related U.S. Application Data
(60) Provisional application No. 61/246,030, filed on Sep. 25, 2009.
(60) Provisional application No. 61/331,295, filed on May 4, 2010.

(51) Int. Cl. F16B 13/06; B21K 1/58

(52) U.S. Cl. 411/44; 470/29

(57) ABSTRACT

Blind fasteners and methods of manufacture. The blind fasteners each have a sleeve with a sleeve head thereon and a stem having a stem head thereon. The stem extends through the sleeve from an end of the sleeve opposite the sleeve head with the stem head adjacent the end of the sleeve opposite the sleeve head. The sleeve has a non-uniform wall thickness to cause the sleeve to buckle outward against a blind side surface of a work piece to form a blind side head when the stem is pulled relative to the sleeve head to set the fastener in a work piece, the work piece having a thickness which may range from a predetermined minimum grip to a predetermined maximum grip. Various embodiments are disclosed.

### CROSS-REFERENCE TO RELATED APPLICATIONS

This application claims the benefit of U.S. Provisional Patent Application No. 61/246,030 filed Sep. 25, 2009 and U.S. Provisional Patent Application No. 61/331,295 filed May 4, 2010.

### BACKGROUND OF THE INVENTION

1. Field of the Invention

The present invention relates to the field of blind fasteners, including blind rivets and blind bolts.

2. Prior Art

Blind fasteners are fasteners that may be inserted into a hole in a work piece to be joined (the work piece typically being two or more sheets or pieces to be joined) and installed without having access to the opposite side of the work piece. In the case of blind rivets and blind bolts, the fasteners are installed by inserting the fastener in a hole in the work piece and either pulling the stem of the fastener relative to the sleeve and sleeve head of the fastener or by rotation of the stem within the sleeve or sleeve head. In either case, the blind side head is formed by the yielding of the sleeve under the resulting compressive load, which, because the sleeve is confined by the stem therein, buckles outward to form the blind side head.

In such fasteners, proper formation of the blind side head is critical to the fastener performance. In particular, blind fasteners are expected to form a well defined blind head against the back sheet of a work piece within the expected grip range specified by the fastener design. Grip is the thickness of the work piece, the grip range being defined by the maximum grip and minimum grip specified for the specific fastener. The common value for the grip range is 0.0625″ ( 1/16″).

A simplified schematic presentation of an exemplary blind fastener is shown in FIG. 1, illustrating a blind rivet and/or blind bolt before and after pulling, in both a maximum grip and associated minimum grip. The installation is achieved by pushing the head end of the fastener against the work piece and applying force (F) at the stem end, thus deforming the sleeve against the work piece at the blind side of the work piece. The installation is complete when a step in the outer diameter of the stem bottoms out on a step in the inner diameter of the sleeve (not shown) and the stem breaks off at a specific location flush with the sleeve head. The stem is locked in place by means of a locking mechanism (also not shown), as is well known in the prior art.

For a sleeve of uniform material strength, as the sleeve end is compressed by the stem applying the force (F) to the back end of the sleeve, the sleeve, having a thin wall and longer in length than the respective diameter of the fastener shank, begins to buckle at the mid point of the exposed sleeve section, as shown in FIG. 2, bulging outwardly and forming the blind head. Thus for a uniform material strength sleeve, the tendency is to form the blind head away from the back side of the work piece. This type of blind head formation is not desirable since it does not bear against the work piece to give it the desired mechanical properties expected for the fastener.

To achieve the desired blind head formation, the sleeve must have differential strength such that the weakest portion is always in close proximity to the back side of the work piece. Thus on initial pull of the stem, the weaker portion of the sleeve immediately adjacent the back side of the work piece deforms first, and forms the blind head, bearing against the work piece as desired (see FIG. 3).

One approach which is very common in the industry for producing differential strength in the sleeve is to employ a thermal treatment that selectively softens the material of the sleeve. There may be numerous heat sources for the selective annealing process. The most common and in practice today is called the induction annealing process. This induction annealing process has shown to be effective for materials such as A-286, Monel, Titanium and alloy steel, but is inadequate for aluminum alloys. Desirable results may be experienced using low temperatures and extended times for the thermal processing of aluminum but is not practical for production purposes.

### BRIEF DESCRIPTION OF THE DRAWINGS

FIG. 1 schematically illustrates a blind rivet before and after the installation process by pulling action, in both a maximum grip and associated minimum grip.

FIG. 2 illustrates how a sleeve of uniform strength begins to buckle at the mid point of the exposed sleeve section at the blind side of the fastener.

FIG. 3 illustrates how a sleeve of progressive strength buckles at the lowest strength point adjacent the blind side work piece surface.

FIGS. 4a through 4f illustrate an exemplary series of header operations to form a sleeve.

FIGS. 4g through 4j illustrate an exemplary series of header operations to form a sleeve.

FIG. 4k illustrates a drilling operation on the sleeve of FIG. 4j.

FIG. 5a illustrates the sleeve of FIG. 4f with the desired buckling region defined by a progressive thinning of the wall of the sleeve, in this embodiment from an inside diameter of the sleeve.

FIG. 5b schematically illustrates a blind rivet using the sleeve of FIG. 5a before and after the installation process by pulling action, in both a maximum grip and associated minimum grip.

FIG. 6a through FIG. 6f illustrate various alternate configurations of the sleeve buckling region.

### DETAILED DESCRIPTION OF THE PREFERRED EMBODIMENTS

The preferred embodiments of the present invention resulted from relevant design and process concepts for manufacturing blind fasteners, utilizing forming processing for manufacturing of sleeves and incorporating a complementary machining process, to achieve final geometrical design. It was desired that the resulting product perform equivalent to aerospace fasteners currently available in the industry. The present invention may also be extended to blind fasteners of similar design made from different material combinations, and are expected to have superior mechanical and installation characteristics.

### Achieving Differential Strength

A primary object of the present invention is for manufacturing the sleeve component from aluminum alloys. These alloys are easily cold formed. One of the properties of metals is that during the cold forming process, the metal increases in strength, and is normally referred to as cold working. This cold working increases the material strength and consequently the hardness of the material. Generally there is a correlation between hardness and strength (yield strength), so that the two terms may be used interchangeably herein.

Sleeves are normally formed on headers by a process called cold forming (some materials may require forming at higher temperatures). The challenge is to incorporate the correct geometry and material strength in the buckling region that will cause the sleeve to deform in the desired manner.

This requires the exposed region of a sleeve outside of the work piece to have differential or progressive strength so that it will buckle outward adjacent the blind side work piece surface, regardless of grip, and bear against the blind side of the work piece. As stated before, in the prior art, this was achieved by providing a uniform thickness in this part of the sleeve and a progressive hardness or material strength from approximately the minimum grip region out to the blind end of the sleeve.

In the present invention, the progressive strength of the sleeve from approximately the minimum grip region out toward the blind end of the sleeve, having uniform material strength, is obtained by appropriately thinning the wall of the sleeve, in the embodiments disclosed herein, by thinning the sleeve from the inner diameter.

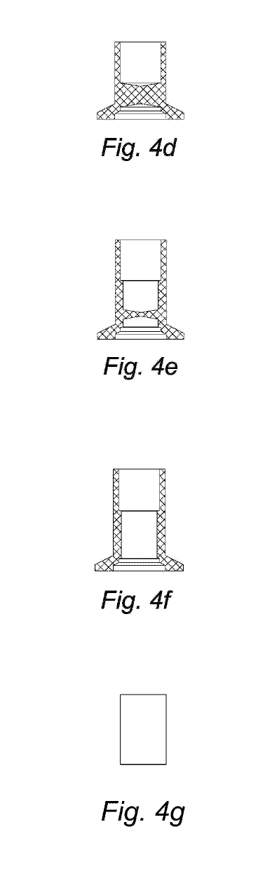

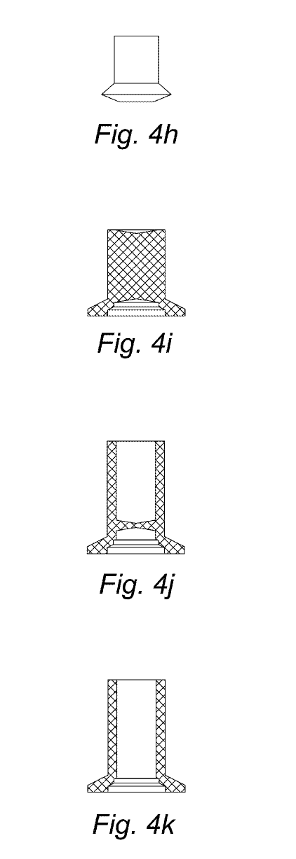

An exemplary process for forming sleeves in accordance with the present invention may be seen in FIGS. 4a through 4f. In FIG. 4a, a length of wire (aluminum in a preferred embodiment) is cut, sleeve head end is upset (FIG. 4b). Then the sleeve head end is finish formed (FIG. 4c) and the blind end is extruded (FIG. 4d). The blind end of the sleeve is then further extruded to form the step (FIG. 4e), and then the remaining center slug is punched out (deslugged). Using this process, it has been found that the resulting hardness (material strength) of the sleeve above the inner diameter step is quite uniform, though this is not a limitation of the invention.

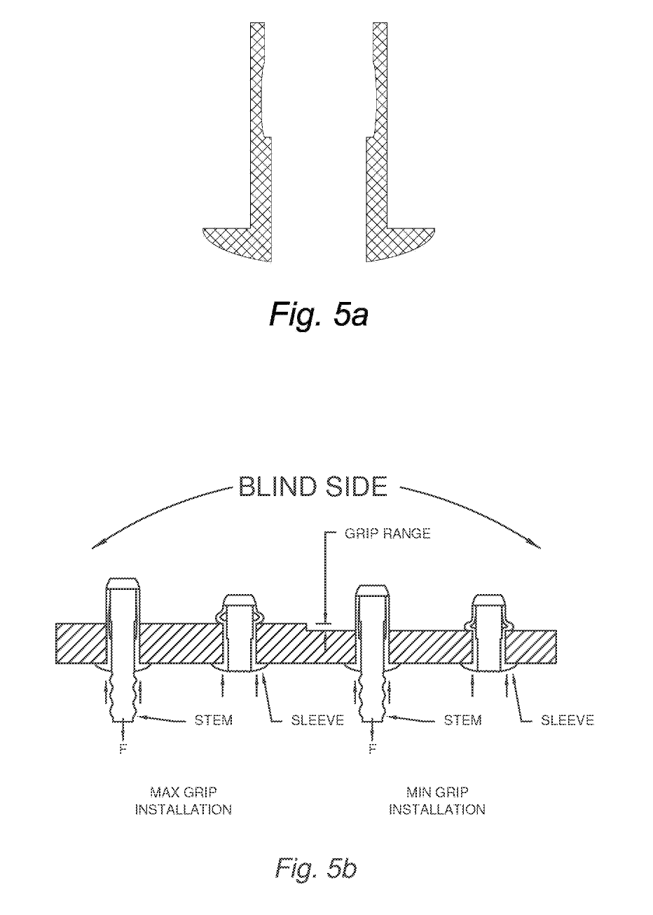

Then as a secondary operation in the exemplary process, the inner diameter of the sleeve above the step is formed to provide a desired variation in the thickness of the sleeve, as shown in FIG. 5a (the specific sleeve shown in FIG. 5a has a different head configuration than the sleeve of FIGS. 4a through 4f, as the head configuration used will vary with the specific fastener being manufactured, though the specific head configuration used forms no part of the present invention). In one embodiment, the thickness variation is made by a secondary machining operation, though it may be possible to form the desired indentation on the inner diameter of this part of the sleeve by other techniques, such as by rolling or even by some expanding mandrel in a heading operation prior to or after the deslugging.

Assuming for the moment a uniform material strength in the sleeve, at least above the step in the inner diameter, a minimum thickness adjacent the step and linearly tapering inward and toward an increasing thickness adjacent the blind end would provide a desired progressive strength in the blind side of the sleeve. This provides uniform material strength and differential thickness of the blind end of the sleeve. However, it has been found that the shape shown in FIG. 5, namely a thickness at the step substantially equal to the thickness of the sleeve at that location before the indentation is made, arcing outward to decrease the sleeve thickness, and then arcing back inward to the thickness of the sleeve before the indentation is made provides superior blind side head forming capability for the sleeve. This geometry provides uniform material strength, differential thickness and direction to the outward buckling motion of the blindside head of the sleeve. The exact shape for best blind head forming may vary depending on such things as the specific heading sequence used, the material used, the material condition, the heading temperature, etc. In a preferred embodiment for an aluminum sleeve, the finished sleeve of FIG. 5a is given a low temperature annealing of 1 to 5 hours at a temperature of 200 to 500° Fahrenheit.

FIG. 5b schematically illustrates the use of the sleeve of FIG. 5a in a fastener of the general type under consideration. In particular, FIG. 5b schematically illustrates a blind rivet using the sleeve of FIG. 5a before and after the installation process by pulling action, in both a maximum grip and associated minimum grip.

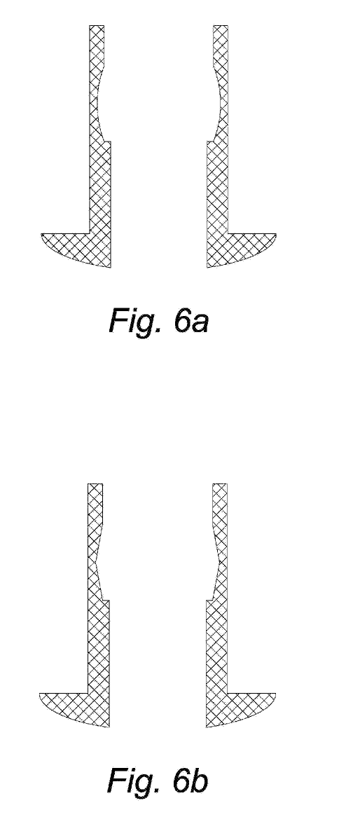

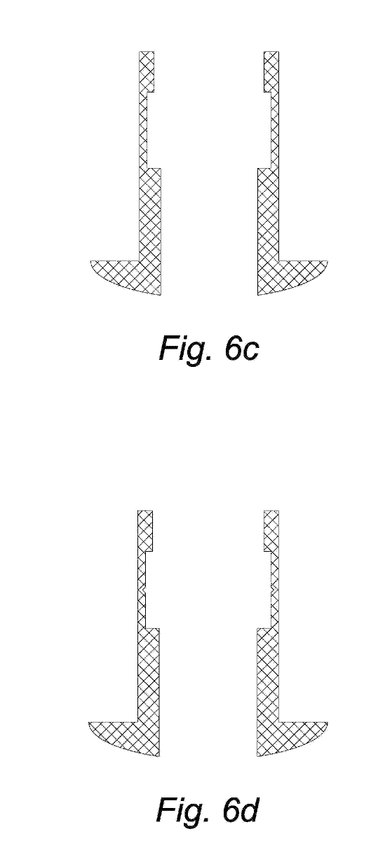

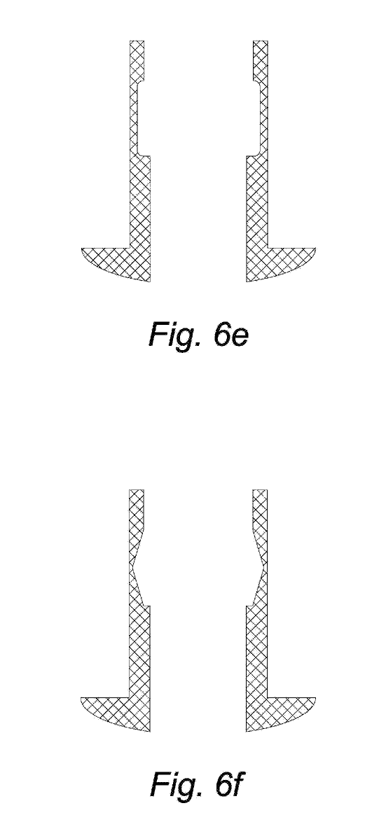

FIGS. 6a through 6f illustrate other possible indentations that might be used. As a further alternative, it may be possible to provide a suitable indentation in the outer diameter of the sleeve above the step in the inner diameter. Such an indentation would be expected to initially tend to cause an inward buckling, though such buckling would be prevented by the fastener stem in the sleeve, with the compressive yielding of the sleeve material ultimately causing the desired outward buckling.

Thus in accordance with the present invention, the sleeve thickness is varied in the region of the sleeve wherein the blind side head is to be formed, the thickness being varied along the sleeve as appropriate for the material, etc. to form the desired blind head, regardless of grip (work piece thickness). For aluminum sleeves in fasteners in accordance with the NAS1900 Specification, the present invention provides sleeves that form blind side heads that bear against the blind side of the work piece, regardless of grip (within a specification range) that safely exceed the specification mechanical characteristics.

### ADVANTAGES OF THE PRESENT INVENTION

The present invention has a number of advantages, including providing:

1. A more uniform bulb against the work piece.

2. Ease of manufacturing. The cold work that is defined by the material characteristics of the material being used is irrelevant. Buckling is dependent on the geometry of the contour which is mechanical and not on the strength and degree of cold work resulting from a cold heading process.

3. Improved corrosion properties. In the case of aluminum, a low temperature anneal after manufacture of the sleeve enhances corrosion resistance compared to those components that are not thermally treated.

4. A predictable installation bulb form and bulb form diameter.

5. Time consuming and expensive drilling necessary to form the inner diameters of the sleeve is eliminated.

As an alternative, sleeves in accordance with the present invention may be formed by first forming a sleeve blanks in a header in accordance with the series of header operations to form sleeve blanks as in FIGS. 4g to 4j. After the operation of FIG. 4j, the inner diameters of the sleeve blank are slightly less than the finished smaller inner diameter of the sleeve. Then the sleeve blank is put in a CNC machine and the smaller diameter of the finished sleeve is drilled or reamed to its finished diameter, and the larger sleeve inner diameter and the inner wall is machined to form the larger sleeve inner diameter and thin the wall of the sleeve to the final form of the sleeve, as shown in FIG. 5a, or FIGS. 6a though 6f.

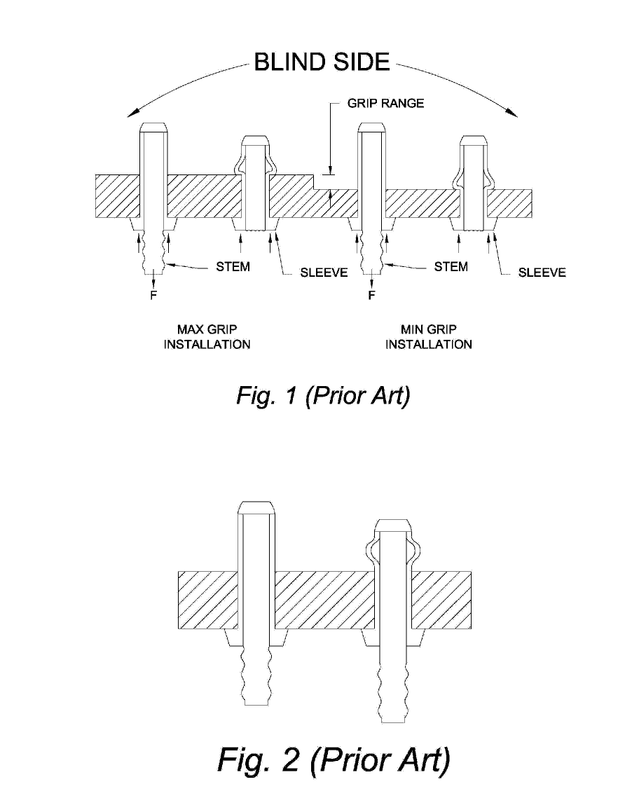

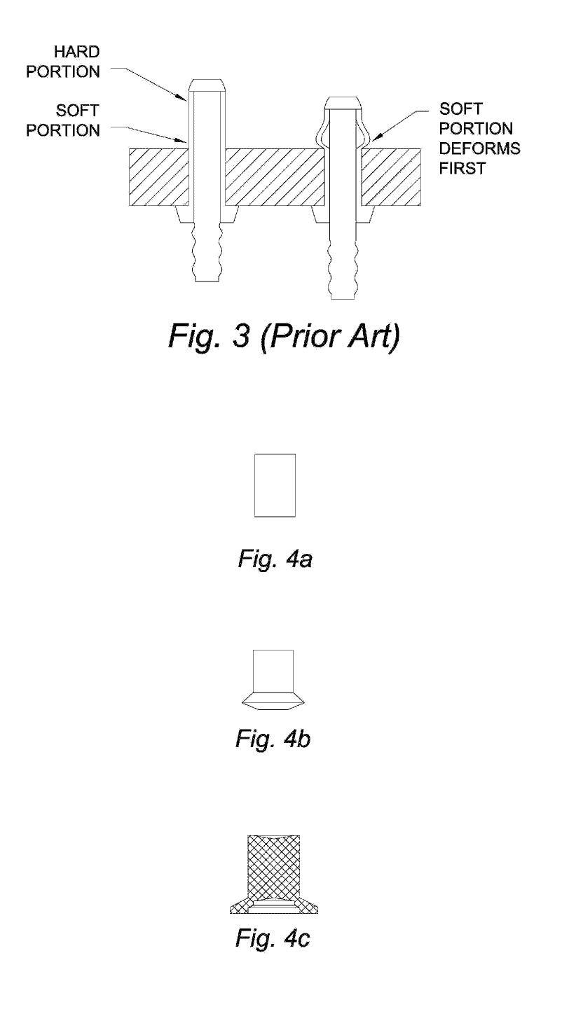

It should be noted that FIGS. 4a through 4k illustrate sleeves with a countersunk head, while FIGS. 5a through 6f illustrates a universal head, and FIGS. 1 through 3 simply schematically illustrate a generic head. However the head form used is not an aspect of the present invention, as the formation and use of various head forms is well known in the art.

Thus while certain preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. A blind fastener comprising:
a sleeve with a sleeve head thereon;
a stem having a stem head thereon;
the stem extending through the sleeve from an end of the sleeve opposite the sleeve head with the stem head adjacent the end of the sleeve opposite the sleeve head;
the sleeve having a non-uniform wall thickness to cause the sleeve to buckle outward against a blind side surface of a work piece to form a blind side head when the stem is pulled relative to the sleeve head to set the fastener in a work piece, the work piece having a thickness which may range from a predetermined minimum grip to a predetermined maximum grip.

2. The blind fastener of claim 1 wherein the sleeve has a cylindrical outer diameter, an inner diameter of a blind side head forming region of the sleeve having a region of increased diameter in comparison to the inner diameter of the sleeve at the blind side end of the sleeve to encourage buckling of the sleeve adjacent a blind side surface of the workpiece independent of grip, within the range of the predetermined minimum grip to the predetermined maximum grip.

3. The blind fastener of claim 2 wherein the stem has a step in outer diameter to a larger outer diameter adjacent the stem head, the sleeve having a step in its inner diameter to a larger inner diameter a fixed distance from the sleeve head, whereby the engagement of the larger outer diameter of the stem adjacent the stem head with the step in the sleeve inner diameter will limit the extent of the travel of the stem into the sleeve during setting of the fastener.

4. The blind fastener of claim 3 wherein the region of the sleeve having a region of increased diameter in comparison to the inner diameter of the sleeve at the blind side end of the sleeve begins at the step in the sleeve inner diameter to a larger inner diameter.

5. The blind side fastener of claim 4 wherein the distance from the sleeve head to the step in the sleeve inner diameter to a larger inner diameter is closer to the sleeve head than the minimum grip.

6. The blind fastener of claim 4 wherein the stem has a pulling end extending out from the sleeve head.

7. A blind fastener comprising:
a sleeve having a sleeve head on a first sleeve end and a uniform outer diameter extending from the sleeve head to a second sleeve end;
a stem having a stem head at a first stem end, a pulling region adjacent a second end thereof opposite the stem head, a cylindrical region of a first diameter adjacent the pulling region and extending toward the stem head, and a step to a cylindrical region of a second diameter larger than the first diameter extending from the cylindrical region of a first diameter to the stem head;
the sleeve having a region of a first inner diameter extending from and through the sleeve head to part way along the sleeve, and a second inner diameter larger than the first inner diameter at the second sleeve end;
the sleeve having a region having an inner diameter larger than the second inner diameter to cause the sleeve to buckle outward against a blind side surface of a work piece to form a blind side head on the second sleeve end when the pulling region of the stem is pulled relative to the sleeve head to set the fastener in a work piece having a thickness which may range from a predetermined minimum grip to a predetermined maximum grip.

8. The blind fastener of claim 7 wherein the region of the sleeve having an inner diameter larger than the second inner diameter to cause the sleeve to buckle outward against a blind side surface of a work piece extends to the region of a first inner diameter.

9. The blind fastener of claim 8 wherein the inner diameter of a blind side head forming region of the sleeve having a region of increased diameter in comparison to the inner diameter of the sleeve at the blind side end of the sleeve to encourage buckling of the sleeve adjacent a blind side surface of the workpiece independent of grip, within the range of the predetermined minimum grip to the predetermined maximum grip.

10. A method of manufacturing a blind fastener comprising:
fabricating a sleeve blank having a sleeve head on a first sleeve blank end, a uniform outer sleeve diameter extending from the sleeve head to a second sleeve blank end, a first sleeve blank inner diameter extending through the sleeve head and extending part way along the sleeve blank, and a second sleeve blank inner diameter extending from the second sleeve blank end toward the first sleeve diameter, the second sleeve blank inner diameter being greater than the first sleeve blank inner diameter, and both inner diameters being less than finished diameters;
opening the first and second sleeve blank inner diameters to their finished diameters, and cutting a sleeve inner diameter region to provide an inner diameter larger than the second inner diameter to cause the sleeve to buckle outward against a blind side surface of a work piece to form a blind side head on the second sleeve end when the pulling region of the stem is pulled relative to the sleeve head to set the fastener in a work piece having a thickness which may range from a predetermined minimum grip to a predetermined maximum grip;
fabricating a stem having a head at a first stem end, a pulling region adjacent a second end thereof opposite the first stem end, a cylindrical region of a first diameter adjacent the pulling region and extending toward the stem head, and a step to a cylindrical region of a second diameter larger than the first diameter extending from the cylindrical region of a first diameter to the stem head; and
assembling the blind fastener by passing the pulling region through the second end of the sleeve and out the head of the sleeve.

11. The method of claim 10 wherein the sleeve blank has a slug between the first and second inner diameters that is removed when the first and second sleeve blank inner diameters are opened to their finished diameters, and a sleeve inner diameter region is cut to provide an inner diameter larger than the second inner diameter.
